(19) United States
(12) Patent Application Publication
(10) Pub. No.: US 2023/0129774 A1
(43) Pub. Date: Apr. 27, 2023

(54) Grill Cover Complement II

(71) Applicant: Christopher Joseph McEntee, Saunderstown, RI (US)

(72) Inventor: Christopher Joseph McEntee, Saunderstown, RI (US)

(21) Appl. No.: 17/452,234

(22) Filed: Oct. 25, 2021

(51) Int. Cl. A47J 37/07

(52) U.S. Cl. CPC A47J 37/0786

(57) ABSTRACT

Pests such as rodents commonly enter outdoor cooking grills. Outdoor grills are a source of food and shelter for pests. The filth associated with pests can not only contaminate grill surfaces and threaten the health and safety of grill cooking, it can also affect the enjoyment of eating food from an outdoor grill. Conventional grill covers do not solve this problem. The device addressed in this application provides a simple solution for the problem. The device attaches to the bottom edge of the typical grill cover and blocks access into the grill by pests.

### BACKGROUND OF INVENTION

Outdoor cooking with gas grills is common in the United States. Many grills are covered while not in use to protect against the elements. The typical grill cover is draped over the top of the grill and is designed to protect the grill against wind, rain, snow, sleet, sunlight, etc. While the typical grill cover envelops most of the area of the grill from the top downward, it does not cover the bottom area of the grill.

The invention described here (also referred to as the “complement” and the “device”) is designed to cover the bottom area of the grill and thereby protect against intrusion into the grill by pests (e.g., rodents).

### BRIEF SUMMARY OF INVENTION

This invention is a device that covers the lower part of the grill. It is not intended as a stand-alone solution. Rather, it is a device that complements the typical drape-like grill cover. While positioned below the grill, this invention integrates—“pulls in”—the lower edges of the typical grill cover. This then covers all access points into the grill.

### BRIEF DESCRIPTION OF THE DRAWINGS

FIG. 1 is a perspective view of the invention showing three fixed “fences” and one detachable “gate.”

FIG. 2 is a perspective view of the invention showing the detachable gate secured to the device.

FIG. 3 is a perspective view of the two-part “belt” used to secure a grill cover to the device.

FIG. 4 is a perspective view showing a grill positioned on the device with the grill cover secured to the device by the belt.

### DETAILED DESCRIPTION AND BEST MODE OF IMPLEMENTATION

The invention has a flat, rectangular bottom which sits below the grill and measures a similar depth and width of the grill bottom. Attached to the bottom of the device are three fixed fences—the back and side fences. A detachable gate serves as the front side of the device. The fences and gate rise vertically for approximately 4 inches from the invention's bottom and then move outward at a 90-degree angle for approximately 1.5 inches. This 1.5-inch section runs along the top of the fences and gate and meets at the four corners of the device. So, at each corner, the top of the fences/gate extend outward 45 degrees beyond the end of the fence/gate. This way, the lateral surfaces atop the upper fences and gate continue until meeting at each corner. Lastly, the front (gate side) of the base has two ramps, which enable rolling of the grill on to the base.

The invention is designed for use after a grill has been rolled on to the device, after the gate has been attached to the device, and after the grill has been covered by a typical grill cover. Once these actions have occurred, the lower edge of the grill cover will be positioned aside the upper lateral sections of the fences and gate. Then the three-sided, slide-binder-like belt section is attached to the upper parts of the fences, with the back fence secured firstly and the side fences secured secondly by utilizing the slide action of the side belt sections. Next, the one-sided, slide-binder-like belt section is attached to the upper part of the gate, and to the near corners of the three-sided belt section. This then pulls in the lower edge of the grill cover under the belt.

In sum, the intent is to slide each section of the belt over the 1.5-inch lateral sections atop the fences and gate, and capture in between the bottom edge of the typical grill cover. Once the belt is fully in place, access under the grill or under the grill cover is not possible. The entire grill will then be covered and protected against intrusions by pests.

Ventilation is an important aspect of safe cooking with propane gas grills. As such, the invention has multiple vents to enable air flow through the fences, gate, and bottom.

There are multiple objectives of the invention. First, the invention will prevent animal access below the grill and below the typical grill cover. Second, the thin slits along the fences, gate, and base will enable proper ventilation beneath the grill. Third, the invention will be constructed of heat-resistant material to ensure, along with proper ventilation, that the grill cover complement will not cause overheating. Fourth, the heat-resistant material will enable the grill to remain stationed on the base of the device not only during storage of the grill but also during cooking.

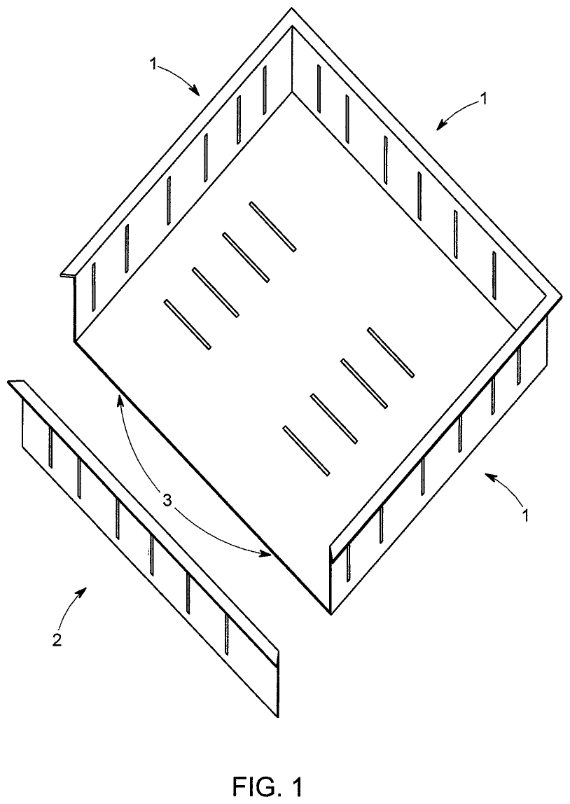

In FIG. 1, the fixed back and side fences 1 are illustrated. The detachable front gate 2 is positioned in front of the device to enable viewing the point of access of the grill onto the base of the device. The narrow ramps 3 along the point of access on the gate-side of the device are also illustrated. The ramps facilitate grill entry onto the device. Further, from the ramps to the back fence, rubber material extends below the device on each side of the device's bottom. The rubber material underneath prevents the device from slipping while positioning the grill onto the device.

The rubber material underneath also elevates the vented area at the bottom of the device. And the rubber underneath will allow for an even distribution of the weight of the grill onto the rubber to avoid collapse of the elevated bottom.

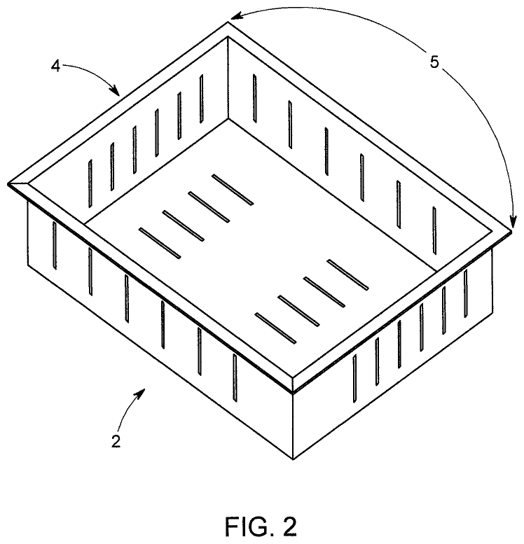

In FIG. 2, multiple vents 4 along the fences, gate, and bottom of the device are illustrated. This figure illustrates the detachable gate 2 secured to the cover complement, with a flush seal along the bottom of the device. This figure also illustrates the upper sections of the fences and gate 5 jutting outward at a 90-degree angle and meeting in the four corners of the device.

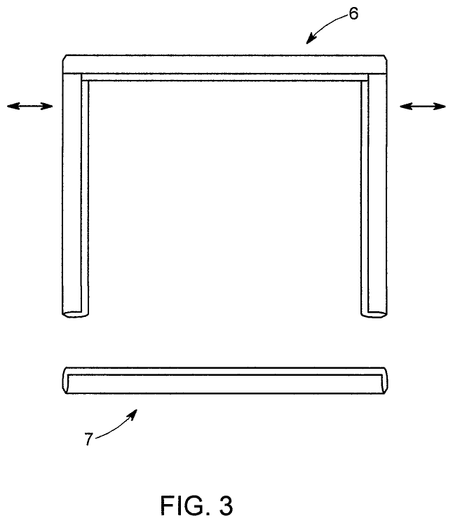

In FIG. 3, the two-part belt is illustrated. The belt is a slide-binder like device, which is approximately two inches deep with an approximate ¼ inch of inner space separating the top and bottom on the inside. Each side of the belt measures the respective length of the fences and gate, from corner to corner. The three-sided belt section 6 is designed to, first, attach to the lateral surface of the upper back fence over the lower edge of the grill cover, and then, second, slide inward on the sides and attach to the lateral surfaces of the upper side fences and over the lower edge of the grill cover. The one-sided belt section 7 is designed to attach to the lateral surface of the upper gate over the lower edge of the grill cover while being secured to the front corners of the three-sided belt section. The connected belt will thereby envelope both the upper fences/gate and the lower edges of the grill cover.

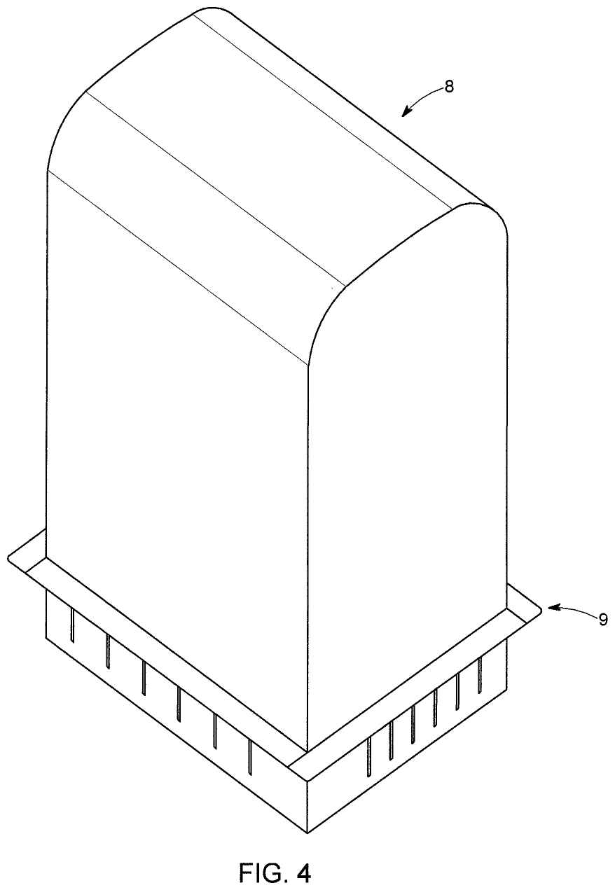

In FIG. 4, the covered grill 8 is positioned on the device and is enclosed by the three fixed fences and by the detachable gate. This drawing illustrates the crucial function of this invention—the belt securing the bottom of the grill cover 9 to the fences and gate, thereby preventing access into the grill area.

1. A device that sits beneath a grill and attaches to the bottom edge of a cloth, drape-like grill cover, and thereby blocks pests from entering the grill.
